(19) United States
(12) Patent Application Publication
(10) Pub. No.: US 2015/0365360 A1
(43) Pub. Date: Dec. 17, 2015

(54) METHOD AND APPARATUS FOR PROCESSING PUSH MESSAGE IN NOTIFICATION CENTER OF MOBILE TERMINAL, AND STORAGE MEDIUM

(71) Applicant: TENCENT TECHNOLOGY (SHENZHEN) COMPANY LIMITED, Shenzhen citiy, Guangdong (CN)

(72) Inventors: Cancai YUAN, Shenzhen, Guangdong (CN); Jintao QIU, Shenzhen, Guangdong (CN); Lei LONG, Shenzhen, Guangdong (CN); Sensheng XU, Shenzhen, Guangdong (CN)

(21) Appl. No.: 14/763,737

(22) PCT Filed: Nov. 15, 2013
(86) PCT No.: PCT/CN2013/087260

§ 371 Date: Jul. 27, 2015

(30) Foreign Application Priority Data
Feb. 1, 2013 (CN) 201310041464.2

(51) Int. Cl. H04L 12/58; H04L 29/08; H04W 88/02

(52) U.S. Cl. CPC H04L 51/04; H04W 88/02; H04L 51/24; H04L 51/38; H04L 67/26

(57) ABSTRACT

Disclosed are a method and an apparatus for processing a push message in a notification center of a mobile terminal, and a storage medium. The present invention relates to the field of terminal devices. The method comprises: establishing a specified clearing option in a notification center of a mobile terminal, the notification center being used for displaying a push message of each application and a processing option of each push message; and when a triggering instruction for the specified clearing option is received, clearing a displayed push message of each application according to a preset rule, the preset rule being used for determining push messages capable of being cleared in one time in the notification center. The apparatus comprises an establishing module and a clearing module.

The application claims priority to Chinese Patent Application No. 201310041464.2, filed by Tencent Technology (Shenzhen) Co., Ltd. on Feb. 1, 2013, and titled “METHOD AND APPARATUS FOR PROCESSING PUSH MESSAGE IN NOTIFICATION CENTER OF MOBILE TERMINAL”, which is incorporated herein by reference in its entirety.

### FIELD OF THE TECHNOLOGY

The present disclosure relates to the field of terminal devices, and in particular, to a method and an apparatus for processing push messages on a notification center of a mobile terminal, and a storage medium.

### BACKGROUND OF THE DISCLOSURE

With the development of network technologies and terminal technologies, multiple applications (App) can be installed on a mobile terminal. A user can operate the installed applications to implement various functions, for example, browsing a web page, and chatting. To provide a user operating the mobile terminal with information about applications, the mobile terminal is provided with a notification center. The notification center can provide push messages about the applications to the user. The user may view the push messages to know about the latest status of the applications.

When intending to remove a push message, the user needs to click on a removing button of the push message provided by the notification center, so as to implement removing of the push message.

For the existing method for removing a push message, the inventor finds that it has at least the following problems:

When a large number of push messages exist in a notification center, a user has to click on each of the removing buttons for the respective push messages. Such a huge number of removing operations increase complexity of user operations of the mobile terminal and require much time, resulting in low removing efficiency.

### SUMMARY

To improve efficiency of removing push messages, embodiments of the present invention provide a method and an apparatus for processing push messages on a notification center of a mobile terminal, and a storage medium. The technical solutions are as follows.

According to an aspect, an embodiment of the present invention provides a method for processing push messages on a notification center of a mobile terminal. The method includes:

creating a specified removing option on the notification center of the mobile terminal, the notification center being configured to display the push messages for applications and a processing option for each of the push messages; and removing the displayed push messages for applications according to a preset rule when a triggering instruction for the specified removing option is received, the preset rule being used for determining push messages that can be removed at once from the notification center.

According to another aspect, an embodiment of the present invention further provides an apparatus for processing push messages in a notification center of a mobile terminal. The apparatus includes:

a creation module, configured to create a specified removing option on the notification center of the mobile terminal, the notification center being configured to display the push messages for applications and a processing option for each of the push messages; and

a removing module, configured to remove the displayed push messages for applications according to a preset rule when a triggering instruction for the specified removing option is received, the preset rule being used for determining push messages that can be removed at once from the notification center.

According to still another aspect, an embodiment of the present invention provides a storage medium including a computer-executable instruction, the computer-executable instruction being used for executing a method for processing push messages on a notification center of a mobile terminal, the method including the following steps:

creating a specified removing option on the notification center of the mobile terminal, the notification center being configured to display the push messages for applications and a processing option for each of the push messages; and

removing the displayed push messages for applications according to a preset rule when a triggering instruction for the specified removing option is received, the preset rule being used for determining push messages that can be removed at once from the notification center.

Beneficial effects of the technical solutions provided by the embodiments of the present invention are as follows.

According to a method and an apparatus for processing push messages on a notification center of a mobile terminal and a storage medium provided by the embodiments of the present invention, a specified removing option is created on the notification center of the mobile terminal, the notification center being used for displaying the push messages for applications and a processing option for each of the push messages; and the displayed push messages for applications are removed according to a preset rule when a triggering instruction for the specified removing option is received, the preset rule being used for determining push messages that can be removed at once from the notification center. When the technical solutions provided by the present disclosure are used, a specified removing option is provided on a notification center, and push messages can be removed at once according to the specified removing option, thereby simplifying user operations, saving time, and improving efficiency for removing push messages.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a flowchart of a method for processing push messages on a notification center of a mobile terminal according to an embodiment of the present invention;

FIG. 2a is a flowchart of a method for processing push messages on a notification center of a mobile terminal according to an embodiment of the present invention;

FIG. 2b is a schematic diagram of a displayed notification center according to an embodiment of the present invention; and

FIG. 3 is a schematic structural diagram of an apparatus for processing push messages on a notification center of a mobile terminal according to an embodiment of the present invention.

### DETAILED DESCRIPTION

To make the objectives, technical solutions, and advantages of the present disclosure clearer, the following describes implementation of the present disclosure in further detail with reference to the accompanying drawings.

In the embodiments of the present invention, a terminal device refers to a device that provides a user with voice and/or data connectivity, and includes a mobile terminal or a fixed terminal. The mobile terminal may be a handheld device having a wireless connection function or other processing device connected to a wireless modem, which can communicate with one or more core networks through a wireless access network. For example, the mobile terminal may be a mobile terminal (or referred to as a “cellular” phone) or a computer having a mobile communications function. For another example, the mobile terminal may also be a portable, pocket-sized, handheld, computer's built-in or vehicle-mounted mobile apparatus. Preferably, the mobile device is a mobile terminal, such as a smart phone.

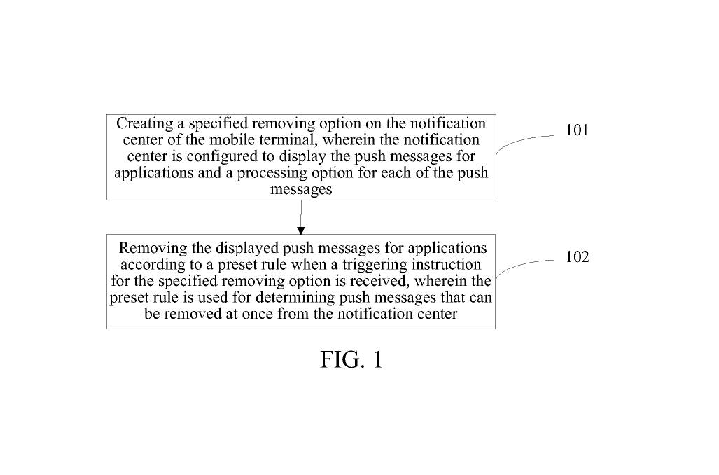

FIG. 1 is a flowchart of a method for processing push messages on a notification center of a mobile terminal according to an embodiment of the present invention. The method may be executed by an apparatus for processing push messages on the notification center of the mobile terminal. The apparatus may be implemented in the form of software and/or hardware, and configured in an electronic device, for example, a smart phone, a desktop computer, a tablet computer or a personal digital assistant, that has a memory and a processor. Preferably, the apparatus is configured in a mobile terminal.

Referring to FIG. 1, the method includes the following steps.

At step 101, a specified removing option is created on the notification center of the mobile terminal. The notification center is configured to display the push messages for applications and a processing option for each of the push messages.

In this embodiment of the present invention, the notification center may be displayed by performing a pull-down operation on the current display page of the mobile terminal. The notification center is a human-machine interaction interface that is used for displaying push messages for applications and a processing option for each of the push messages. The push messages displayed on the notification center include push messages of the applications that have been installed in the mobile terminal, for example, push messages of instant messaging applications, update messages of applications, and update messages of the system. In addition, the push messages of the same application are displayed in a predetermined area, and a processing option is correspondingly displayed for each of the push messages in the predetermined area. The mobile terminal presents processing options to process each push message, so that the user may view and process a single push message. The processing of the push message includes, but is not limited to, to remove the push message, to stop prompting the push message again, or to delay prompting the push message.

When an instruction for displaying the notification center is received, the mobile terminal creates the specified removing option on the notification center. The specified removing option is used for removing multiple push messages displayed on the notification center at once. The specified removing option may be located in a specified area, which may be set by a person skilled in the art during development. The specified area may be a lower left area, lower right area, lower middle area or upper left area of the notification center. Preferably, the specified area is a lower right area of the notification center.

It should be noted that, the specified removing option may be displayed in any form, for example, a button or a slider, which is not limited in this embodiment of the present invention.

At step 102, when a triggering instruction for the specified removing option is received, the displayed push messages for applications are removed according to a preset rule. The preset rule is used for determining push messages that can be removed at once from the notification center.

The triggering instruction may be triggered in response to a triggering operation performed by a user on the specified removing option displayed by the mobile terminal. When the mobile terminal detects the triggering operation performed by the user on the specified removing option, the mobile terminal triggers the triggering instruction for the specified removing option. The triggering operation includes a clicking operation, a sliding operation or any other touching operation on the specified removing option, which is not specifically limited in this embodiment of the present invention.

The preset rule is used for determining which push messages can be removed at once from the notification center. Optionally, the preset rule specify removing all push messages of instant messaging applications, removing all push messages currently displayed or removing all push messages relating to the update of applications. The preset rule may be set by a person skilled in the art during development or by the user of the mobile terminal.

Specifically, when the triggering instruction for the specified removing option is received, the mobile terminal acquires the preset rule, determines push messages that can be removed at once according to the preset rule, and removes the determined push messages at once.

Optionally, removing the displayed push messages for applications according to a preset rule when a triggering instruction for the specified removing option is received includes:

when the triggering instruction for the specified removing option is received, reading a corresponding application identifier for each of the push messages displayed on the notification center; and

according to the preset rule and the read application identifiers, removing push messages which conform to the preset rule from the notification center.

Optionally, according to the preset rule and the read application identifiers, removing push messages which conform to the preset rule from the notification center includes:

acquiring an application removing list according to the preset rule and the read application identifiers, the application removing list including application identifiers of applications that conform to the preset rule; and

according to the application removing list, removing push messages corresponding to the application identifiers in the application removing list from the notification center.

Optionally, before creating a specified removing option on the notification center, the method further includes:

receiving the preset rule which is set by a user, the preset rule being a first preset rule or a second preset rule, where the first preset rule includes application identifiers of applications that are allowed to be removed when the triggering instruction for the specified removing option is received, and the second preset rule includes application identifiers of applications that are not allowed to be removed when the triggering instruction for the specified removing option is received.

Optionally, creating a specified removing option on the notification center includes:

creating the specified removing option on the notification center when the number of the push messages displayed on the notification center is greater than or equal to a preset value.

Optionally, after removing the displayed push messages for applications according to a preset rule when a triggering instruction for the specified removing option is received, the method further includes:
refreshing the notification center, and prompting that the push messages removing operation ends.

Optionally, the method is applied to an iOS system.

According to the method provided by this embodiment of the present invention, a specified removing option is created on a notification center of a mobile terminal, where the notification center is used for displaying push messages for applications and a processing option for each of the push messages; and when a triggering instruction for the specified removing option is received, the displayed push messages for applications are removed according to a preset rule, where the preset rule is used for determining push messages that can be removed at once from the notification center. When the technical solutions provided by the present disclosure are used, a specified removing option is provided on a notification center, and push messages can be removed at once according to the specified removing option, thereby simplifying user operations, saving time, and improving efficiency for removing push messages.

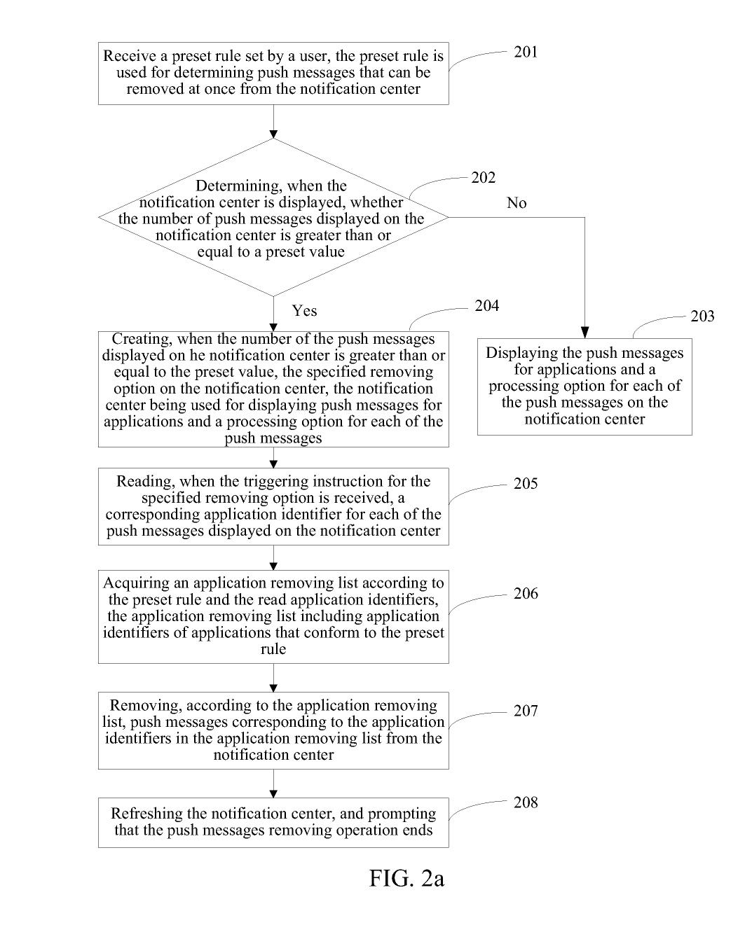

FIG. 2a is a flowchart of a method for processing push messages on a notification center of a mobile terminal according to an embodiment of the present invention. Referring to FIG. 2a, the method includes the following steps.

At step 201, a preset rule set by a user is receiving. The preset rule is used for determining push messages that can be removed at once from the notification center.

The preset rule is a first preset rule or a second preset rule. The first preset rule includes application identifiers of the applications that are allowed to be removed when a triggering instruction for a specified removing option is received, that is, the first preset rule is a blacklist; and the second preset rule includes application identifiers of applications that are not allowed to be removed when the triggering instruction for a specified removing option is received, that is, the second preset rule is a white list.

Accordingly, during setting of the preset rule, the user may set application identifiers of some or all of applications installed in the mobile terminal as application identifiers of applications in the first preset rule, so that when receiving the triggering instruction for the removing option, the mobile terminal removes push messages that correspond to the application identifiers in the first preset rule; or during setting of the preset rule, the user may set application identifiers of some or all of applications installed in the mobile terminal as application identifiers of applications in the second preset rule, so that when receiving the triggering instruction for the removing option, the mobile terminal removes push messages other than the push messages that correspond to the application identifiers in the second preset rule from the notification center.

Step 201 only needs to be performed before step 202, and there is no necessary time succession between the steps. Certainly, during use of the mobile terminal, the user can adjust setting of the preset rule at any time according to personal demands, a recommendation from a network security application or the like, so as to improve removing efficiency and security.

At step 202, when the notification center is displayed, it is determined whether the number of push messages displayed on the notification center is greater than or equal to a preset value, and if yes, step 204 is performed, or if not, step 203 is performed.

The preset value may be set by a developer during design or set independently by a user during use. The preset value may be 1, 2 or the like, which is not specifically limited in this embodiment of the present invention. Preferably, 2 is selected as the preset value.

At step 203, push messages of applications are displayed on the notification center, and for each of the push messages, a processing option is also displayed on the notification center.

When displaying the notification center, the mobile terminal compares the number of acquired push messages with the preset value. When the number of the push messages is smaller than the preset value, push messages of applications are displayed on the notification center and for each of the push messages, a processing option is also displayed on the notification center. As the number of the push messages displayed on the notification center is small, the specified removing option does not need to be created, and instead a processing option is provided for each push message so that the user removes the push messages one by one.

At step 204, when the number of the push messages displayed on the notification center is greater than or equal to the preset value, the specified removing option is created on the notification center. And the notification center is used for displaying push messages of applications and a processing option for each of the push messages.

When displaying the notification center, the mobile terminal compares the number of acquired push messages with the preset value. When the number of the push messages is greater than or equal to the preset value, the specified removing option is create on the notification center. The push messages of applications are displayed, and for each of the push messages, a processing option is also displayed. As the number of the push messages displayed on the notification center is large, the mobile terminal may create, on the notification center, the specified removing option for removing multiple push messages at once, and may also provide, in a preset area of each push message, an option for processing the push message, so that the user may remove all push messages at once or remove a single push message at a time.

Preferably, creating a specified removing option specifically includes: hooking a desktop process Springboard by using a Hook technology for a function related to the display of the notification center; when the function related to the display of the notification center is captured, an opportunity to create the specified removing option on the notification center is acquired, to hook a service of a notification center data management server. The service of the notification center data management server manages the notification center, and creates a mapping server to process push messages (the notification center data management server and the mapping server process messages synchronously). Then it is determined whether the number of the push messages displayed on the notification center is greater than or equal to the preset value. When the number of the push messages displayed on the notification center is greater than or equal to the preset value, the specified removing option is created on the displayed notification center.

FIG. 2b is a schematic diagram of a displayed notification center according to an embodiment of the present invention, with a mobile phone as an example for description. The notification center of the mobile phone displays push messages of two applications, including push messages of instant messaging software A (a message sent by a contact A1 and a message sent by a contact A2), and push messages of game software B (an update message B1 and a notification message B2). In addition, the notification center displays the processing options (“removing” buttons) of the two applications separately. The push messages of the two applications can be removed one by one by using the removing option. Besides, a specified removing option is displayed at the lower right of the notification center. When the specified removing option is triggered, the multiple push messages on the notification center can be removed by the mobile phone at once according to a preset rule.

At step 205, when the triggering instruction for the specified removing option is received, reading a corresponding application identifier for each of the push messages displayed on the notification center.

When detecting the triggering operation of the user on the specified removing option, the mobile terminal triggers the triggering instruction for the specified removing option, and reads a corresponding application identifier of an application for each of the push messages displayed on the notification center, to selectively remove push messages according to application identifiers of applications. The application identifier refers to the name or ID of an application, which is not specifically limited in this embodiment of the present invention.

For push messages displayed on the notification center, several push messages may correspond to one application, that is, the number of application identifiers that are read may be identical to or different from the number of push messages.

At step 206, an application removing list is acquired according to the preset rule and the read application identifiers, the application removing list including application identifiers of applications that conform to the preset rule.

When the preset rule of the mobile terminal is a first preset rule, applications conforming to the first preset rule mean applications corresponding to application identifiers included in the preset rule. The mobile terminal compares each read application identifier with the application identifiers included in the first preset rule, determines that the read application identifier is an application identifier of an application that conforms to the preset rule when the application identifier is included in the first preset rule, and then acquires the application removing list consisting of application identifiers that conform to the preset rule. For example, it is assumed that read application identifiers include A, B, C, and D, and application identifiers in the first preset rule include B, C, and E. The mobile terminal filters the read application identifiers according to the first preset rule, to obtain an application removing list consisting of application identifiers that conform to the first preset rule. The application identifiers in the list include B and C.

In another embodiment of the present invention, the preset rule of the mobile terminal may also be a second preset rule. Applications conforming to the second preset rule mean applications corresponding to application identifiers other than that included in the second preset rule. The mobile terminal compares each read application identifier with the application identifiers included in the second preset rule, and determines that the read application identifier is an application identifier of an application that conforms to the preset rule when the application identifier is not included in the second preset rule, and then acquires the application removing list consisting of application identifiers that conform to the preset rule. For example, it is assumed that read application identifiers include A, B, C, and D, and application identifiers in the second preset rule include B, C, and E. The mobile terminal filters the read application identifiers according to the second preset rule, to obtain an application removing list consisting of application identifiers that conform to the second preset rule. The application identifiers in the list include A and D.

At step 207, according to the application removing list, push messages corresponding to the application identifiers in the application removing list are removed from the notification center.

In this embodiment of the present invention, step 205 specifically includes: determining whether the number of application identifiers included in the application removing list is greater than 0, and if yes, removing push messages corresponding to the application identifiers in the application removing list from the notification center, or if not, refusing to process push messages displayed on the notification center.

Preferably, step 205 includes: removing, by the mobile terminal according to the acquired application removing list, push messages that correspond to application identifiers in the application removing list on a data layer through a created mapping server, and sending a notification to a display layer after removing, so as to refresh the notification center, achieving one-key removing notification. Step 206 and step 207 represent a process of removing push messages conforming to the preset rule from the notification center, according to the preset rule and the read application identifiers.

Step 205 to step 207 represent a process of removing the displayed push messages of applications according to the preset rule, when the triggering instruction for the specified removing option is received.

At step 208, the notification center is refreshed, and it is prompted that the push messages removing operation ends.

The mobile terminal refreshes the notification center, prompts that the push messages removing operation ends, and displays, on the notification center, the remaining push messages without being removed. Thus, the push messages that are displayed on the notification center and conform to the preset rule are all removed once.

Further, the mobile terminal displays the number of push messages removed for this time, so as to visually reflect the removing effect.

Preferably, the method provided by this embodiment of the present invention is applied to an iOS system. Further, the method provided by this embodiment of the present invention is applied to a mobile terminal based on an iOS system.

According to the method provided by this embodiment of the present invention, a specified removing option is created on a notification center of a mobile terminal, where the notification center is used for displaying push messages for applications and a processing option for each of the push messages; and when a triggering instruction for the specified removing option is received, the displayed push messages for applications are removed according to a preset rule, where the preset rule is used for determining push messages that can be removed at once from the notification center. When the technical solutions provided by the present disclosure are used, a specified removing option is provided on a notification center, and push messages can be removed at once according to the specified removing option, thereby simplifying user operations, saving time, and improving efficiency for removing push messages.

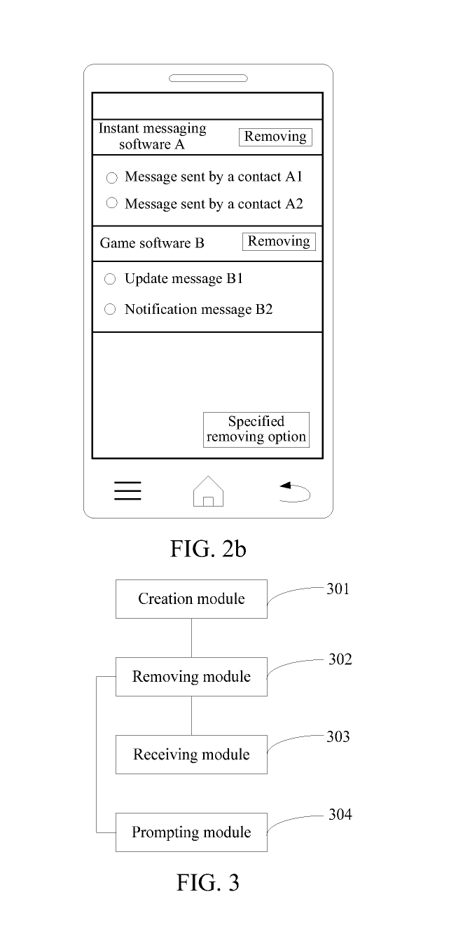

FIG. 3 is a schematic structural diagram of an apparatus for processing push messages on a notification center of a mobile terminal according to an embodiment of the present invention. Referring to FIG. 3, the apparatus includes:

a creation module 301, configured to create a specified removing option on the notification center of the mobile terminal, the notification center being configured to display the push messages for applications and a processing option for each of the push messages; and

a removing module 302, configured to remove the displayed push messages for applications according to a preset rule when a triggering instruction for the specified removing option is received, the preset rule being used for determining push messages that can be removed at once from the notification center.

The removing module 302 includes:

a reading unit, configured to read a corresponding application identifier for each of the push messages displayed on the notification center when the triggering instruction for the specified removing option is received; and

a removing unit, configured to remove push messages which conform to the preset rule from the notification center according to the preset rule and the read application identifiers.

The removing unit is configured to acquire an application removing list according to the preset rule and the read application identifiers, where the application removing list includes application identifiers of applications that conform to the preset rule; and according to the application removing list, remove push messages corresponding to the application identifiers in the application removing list, from the notification center.

The apparatus further includes:

a receiving module 303, configured to receive the preset rule which is set by a user, the preset rule being a first preset rule or a second preset rule, where the first preset rule includes application identifiers of applications that are allowed to be removed when the triggering instruction for the specified removing option is received, and the second preset rule includes application identifiers of applications that are not allowed to be removed when the triggering instruction for the specified removing option is received.

The creation module 301 is configured to create the specified removing option on the notification center, when the number of the push messages displayed on the notification center is greater than or equal to a preset value.

The apparatus further includes:

a prompting module 304, configured to refresh the notification center, and prompt that the push messages removing operation ends.

The apparatus is applied to an iOS system.

According to the apparatus provided by this embodiment of the present invention, a specified removing option is created on a notification center of a mobile terminal, where the notification center is used for displaying push messages for applications and a processing option for each of the push messages; and when a triggering instruction for the specified removing option is received, the displayed push messages for applications are removed according to a preset rule, where the preset rule is used for determining push messages that can be removed at once from the notification center. When the technical solutions provided by the present disclosure are used, a specified removing option is provided on a notification center, and push messages can be removed at once according to the specified removing option, thereby simplifying user operations, saving time, and improving efficiency for removing push messages.

It should be noted that the above functional modules are only described for exemplary purposes when the apparatus for processing push messages on a notification center of a mobile terminal executes processing of push messages on the notification center of the mobile terminal. In practice, the functions may be allocated to different functional modules as desired, that is, the internal structure of the apparatus is divided into different functional modules to complete all or some of the above described functions. In addition, the apparatus for processing push messages on a notification center of a mobile terminal provided by the foregoing embodiments is based on the same concept as the method for processing push messages on a notification center of a mobile terminal in the foregoing embodiments. For the specific implementation of the apparatus and the method, one can refer to the method embodiments described above, and the details are not described herein again.

An embodiment of the present invention further provides a storage medium including a computer-executable instruction, the computer-executable instruction being used for executing a method for processing push messages on a notification center of a mobile terminal, where the method includes the following steps:

creating a specified removing option on the notification center of the mobile terminal, the notification center being configured to display the push messages for applications and a processing option for each of the push messages; and

when a triggering instruction for the specified removing option is received, removing the displayed push messages for applications according to a preset rule, the preset rule being used for determining push messages that can be removed at once from the notification center. The executable instruction in the storage medium may further be used for implementing the method for processing push messages on a notification center of a mobile terminal according to any embodiment of the present invention.

A person of ordinary skill in the art may understand that, all or some of the steps of the foregoing embodiments may be implemented by hardware or by a program instructing relevant hardware. The program may be stored in a computer-readable storage medium. The storage medium may be a read-only memory, a random access memory, a flash memory, a magnetic disk, an optical disc or the like.

The above descriptions are merely preferred embodiments of the present invention, and are not intended to limit the present disclosure. Any modification, equivalent replacement, and improvement made within the spirit and principle of the present disclosure shall fall within the protection scope of the present disclosure.

1. (canceled)

2. A method for processing push messages on a notification center of a mobile terminal, the method comprising:
creating a specified removing option on the notification center of the mobile terminal, wherein the notification center is configured to display the push messages for applications and a processing option for each of the push messages; and
removing the displayed push messages for applications according to a preset rule when a triggering instruction for the specified removing option is received, wherein the preset rule is used for determining push messages that can be removed at once from the notification center,
wherein removing the displayed push messages for applications according to a preset rule when a triggering instruction for the specified removing option is received comprises:
reading a corresponding application identifier for each of the push messages displayed on the notification center, when the triggering instruction for the specified removing option is received; and
removing push messages which conform to the preset rule from the notification center according to the preset rule and the read application identifiers.

3. The method according to claim 2, wherein removing push messages which conform to the preset rule from the notification center according to the preset rule and the read application identifiers comprises:
acquiring an application removing list according to the preset rule and the read application identifiers, wherein the application removing list comprises application identifiers of applications that conform to the preset rule; and
removing push messages corresponding to the application identifiers in the application removing list from the notification center according to the application removing list.

4. A method for processing push messages on a notification center of a mobile terminal, the method comprising:
creating a specified removing option on the notification center of the mobile terminal, wherein the notification center is configured to display the push messages for applications and a processing option for each of the push messages; and
removing the displayed push messages for applications according to a preset rule when a triggering instruction for the specified removing option is received, wherein the preset rule is used for determining push messages that can be removed at once from the notification center,
before creating a specified removing option on the notification center, further comprising:
receiving the preset rule which is set by a user, wherein the preset rule is a first preset rule or a second preset rule, wherein the first preset rule comprises application identifiers of applications that are allowed to be removed when the triggering instruction for the specified removing option is received, and the second preset rule comprises application identifiers of applications that are not allowed to be removed when the triggering instruction for the specified removing option is received.

5. A method for processing push messages on a notification center of a mobile terminal, the method comprising:
creating a specified removing option on the notification center of the mobile terminal, wherein the notification center is configured to display the push messages for applications and a processing option for each of the push messages; and
removing the displayed push messages for applications according to a preset rule when a triggering instruction for the specified removing option is received, wherein the preset rule is used for determining push messages that can be removed at once from the notification center,
wherein creating a specified removing option on the notification center comprises:
creating the specified removing option on the notification center when the number of the push messages displayed on the notification center is greater than or equal to a preset value.

6. (canceled)

7. The method according to of claim 2, wherein the method is applied to an iOS system.

8. (canceled)

9. An apparatus for processing push messages on a notification center of a mobile terminal, the apparatus comprising:
a creation module, configured to create a specified removing option on the notification center of the mobile terminal, wherein the notification center is configured to display the push messages for applications and a processing option for each of the push messages; and
a removing module, configured to remove the displayed push messages for applications according to a preset rule when a triggering instruction for the specified removing option is received, wherein the preset rule is used for determining push messages that can be removed at once from the notification center,
wherein the removing module comprises:
a reading unit, configured to read a corresponding application identifier for each of the push messages displayed on the notification center, when the triggering instruction for the specified removing option is received; and
a removing unit, configured to remove push messages which conform to the preset rule from the notification center according to the preset rule and the read application identifiers.

10. The apparatus according to claim 9, wherein the removing unit is configured to acquire an application removing list according to the preset rule and the read application identifiers, wherein the application removing list comprises application identifiers of applications that conform to the preset rule; and remove push messages corresponding to the application identifiers in the application removing list from the notification center according to the application removing list.

11. An apparatus for processing push messages on a notification center of a mobile terminal, the apparatus comprising:
a creation module, configured to create a specified removing option on the notification center of the mobile terminal, wherein the notification center is configured to display the push messages for applications and a processing option for each of the push messages;
a removing module, configured to remove the displayed push messages for applications according to a preset rule when a triggering instruction for the specified removing option is received, wherein the preset rule is used for determining push messages that can be removed at once from the notification center; and
a receiving module, configured to receive the preset rule which is set by a user, wherein the preset rule is a first preset rule or a second preset rule, wherein the first preset rule comprises application identifiers of applications that are allowed to be removed when the triggering instruction for the specified removing option is received, and the second preset rule comprises application identifiers of applications that are not allowed to be removed when the triggering instruction for the specified removing option is received.

12. An apparatus for processing push messages on a notification center of a mobile terminal, the apparatus comprising:
a creation module, configured to create a specified removing option on the notification center of the mobile terminal, wherein the notification center is configured to display the push messages for applications and a processing option for each of the push messages; and
a removing module, configured to remove the displayed push messages for applications according to a preset rule when a triggering instruction for the specified removing option is received, wherein the preset rule is used for determining push messages that can be removed at once from the notification center,
wherein the creation module is configured to create the specified removing option on the notification center when the number of the push messages displayed on the notification center is greater than or equal to a preset value.

13. (canceled)

14. The apparatus according to claim 9, wherein the apparatus is applied to an iOS system.

15. (canceled)
